(19) United States
(12) Patent Application Publication
(10) Pub. No.: US 2009/0108490 A1
(43) Pub. Date: Apr. 30, 2009

(54) Material curing constructions and methods for curing material

(76) Inventor: Brent Condie, Worley, ID (US)

Correspondence Address: WELLS ST. JOHN P.S., 601 W. FIRST AVENUE, SUITE 1300, SPOKANE, WA, 99201, US

(21) Appl. No.: 11/977,503

(22) Filed: Oct. 24, 2007

(51) Int. Cl. B29C 33/38; B28B 7/36

(52) U.S. Cl. 264/219; 249/15; 249/49; 264/316

(57) ABSTRACT

Form inserts are provided that can include a flexible sheet having multiple ribs extending from at least one surface of the sheet. Methods for curing material are provided that can include expanding a sheet over an interior portion of one form defining a perimeter of material to be cured. The sheet can include ribs extending from a surface of the sheet to within the perimeter. Column form inserts are also provided that can include a plurality of circular ribs defining a perimeter of a column form. Methods of producing a form insert comprising providing a sheet of flexible material and adhering a flexible mesh to the sheet, the flexible mesh forming ribs extending from at least one surface of the sheet, are also provided.

### TECHNICAL FIELD

The present disclosure relates to the curing of materials and more particularly construction materials such as concrete.

### BACKGROUND

Cured construction materials such as concrete play an important, if not necessary, role in modern construction. However, the used of concrete can limit the architectural features of a construction, leaving the building cold and aesthetically displeasing.

### SUMMARY OF THE DISCLOSURE

Form inserts are provided that can include a flexible sheet having multiple ribs extending from at least one surface of the sheet.

Methods for curing material within a form are provided that can include expanding a sheet over an interior portion of one form defining a perimeter of material to be cured. The sheet can include ribs extending from a surface of the sheet to within the perimeter. The material to be cured can be provided to within the form, with the material receiving at least a portion of the ribs of the sheet. The material can be cured, and the sheet removed from the cured material.

Column form inserts are also provided that can include a plurality of circular ribs defining a perimeter of a column form. The ribs can be coupled to one another by interconnecting members to form a frame, for example.

A method of producing a form insert is also provided that can include providing a sheet of flexible material and adhering a flexible mesh to the sheet, with the flexible mesh forming ribs extending from at least one surface of the sheet.

### BRIEF DESCRIPTION OF THE DRAWINGS

Embodiments of the disclosure are described below with reference to the following accompanying drawings.

FIG. 1 is a form insert and orchestration of use of same according to an embodiment.

FIG. 2 is form insert production apparatus according to an embodiment.

FIG. 3 is a form insert and orchestration of use of same according to an embodiment.

FIG. 4 is a detail of a coupled form insert according to an embodiment.

FIG. 5 is a form insert according to an embodiment.

FIG. 6 is a form insert and orchestration of use of same according to an embodiment.

### DESCRIPTION

This disclosure is submitted in furtherance of the constitutional purposes of the U.S. Patent Laws “to promote the progress of science and useful arts” (Article 1, Section 8).

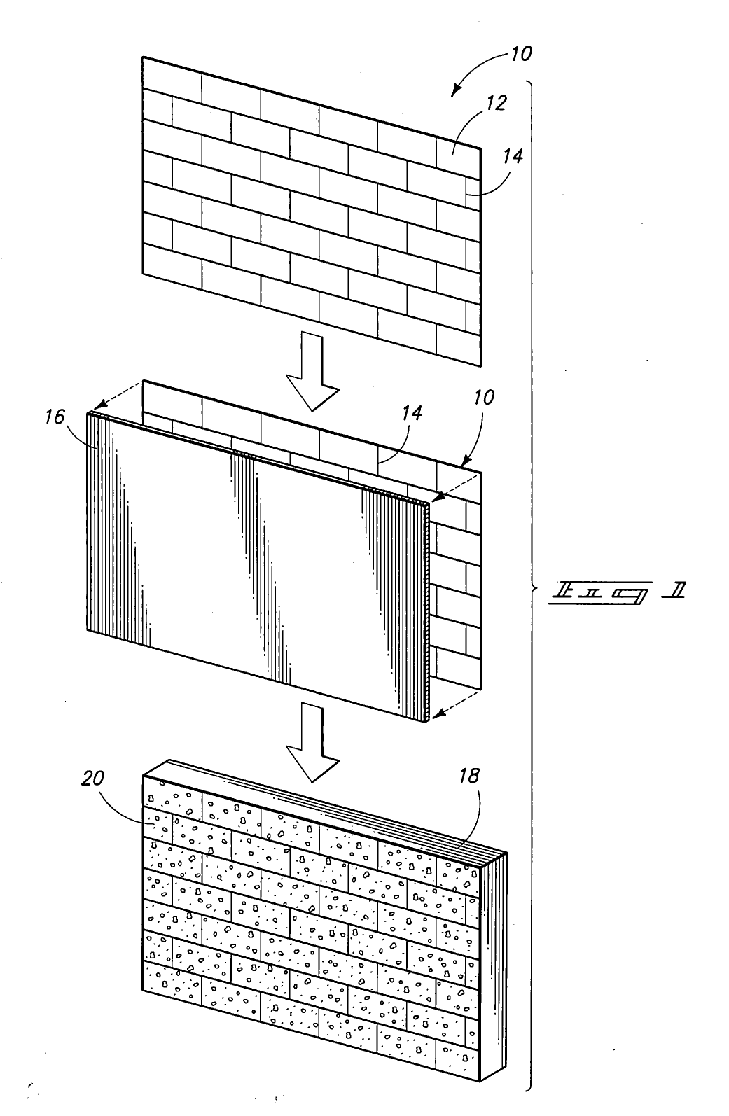

Material curing constructions and methods for curing material are provided with reference to FIGS. 1-6. Referring to FIG. 1, curing construction 10 is shown that includes a flexible sheet 12 having multiple ribs 14 extending from at least one surface of the flexible sheet. Sheet 12 can be constructed of a polymeric material such as polyethylene. Sheet 12 may be from about 3 mils to about 20 mils in thickness. Ribs 14 can also be constructed of a polymeric material such as polyethylene/EPTM. Ribs 14 may extend from the surface of flexible sheet 12 a sufficient amount to engage a material to be cured and form a depression therein upon removal of construction 10 from the cured material. Ribs 14 can extend from about 1/16 inch to about ½ inch. According to an example embodiment, ribs 14 are configured to form a mesh of material, and according to another example embodiment, ribs 14 can be configured to form a decorative pattern. In another embodiment, ribs 14 can be configured to form an architectural feature.

Referring to FIG. 1, construction 10 can be expanded over an interior portion of one form defining a perimeter of a material to be cured. Consistent with the field of art, forms can be used to define a boundary for curing materials such as concrete or any other building construction materials. In this embodiment, the form consists of a semi-, or almost completely flat substrate that forms a perimeter of the material to be cured. As is shown in FIG. 1, construction 10 can be placed against form 16, and construction 10 can be configured with ribs 14 extending from a surface of the sheet within the perimeter defined by the form. In accordance with exemplary methods of curing material, material to be cured within the form can be provided, and the material can receive at least a portion of ribs 14 of sheet 10. The material can then be cured and the sheet removed from the material.

Referring to FIG. 1 again, upon removal of construction 10, ribs 14 provide openings 20 within cured material 18. According to an additional example embodiment, additional materials can be provided between the material to be cured and construction 10 to provide even more additional architectural features. For example, these materials can be provided to demonstrate peaks and/or valleys within the material. Exemplary materials include corrugated paper, for example, or any rough surface materials that can imprint an architectural feature.

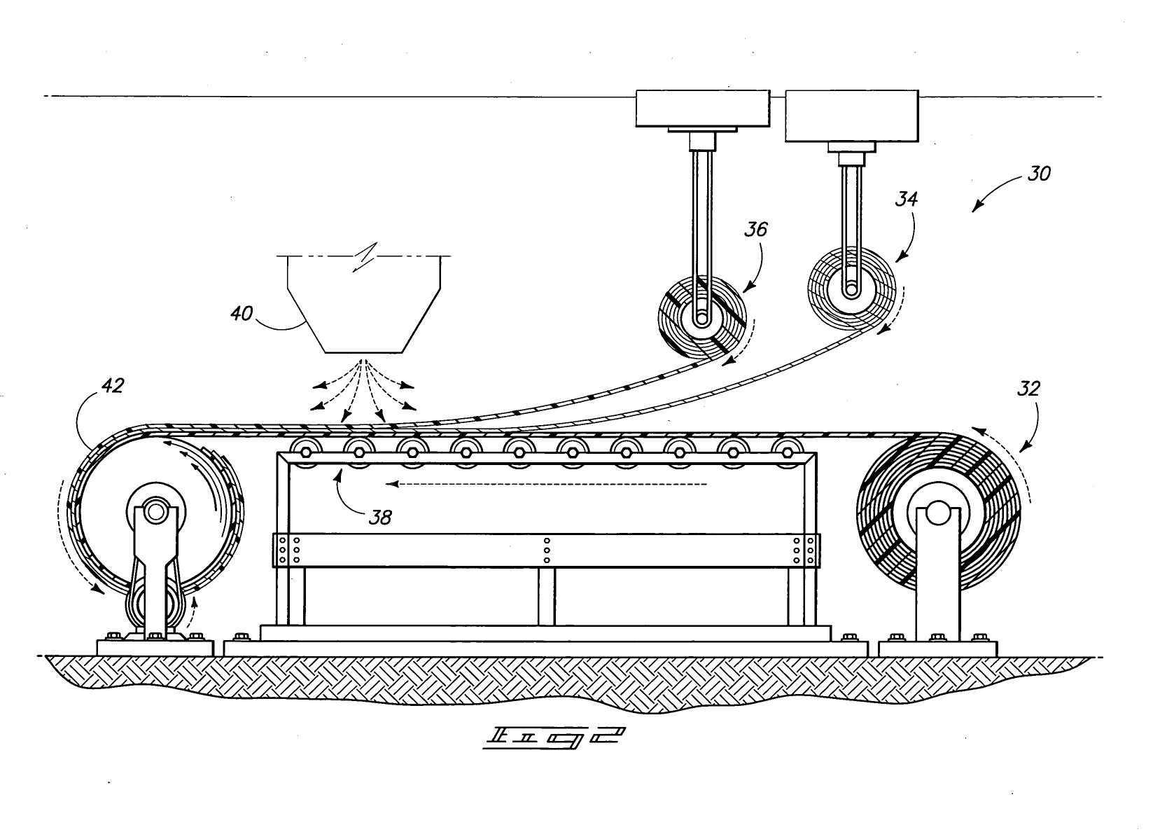

Referring to FIG. 2, an example apparatus 30 for preparing construction 10 is shown. Apparatus 30 can include at least two feed rollers, or as shown, at least three feed rollers. Feed rollers 32, 34, and 36 can be operatively configured across forming bed 38, which can be placed below ceiling apparatus 40, and then upstream of receiving roll 42. According to an exemplary embodiment, apparatus 30 can be used to produce a form insert, and part of the construction can include providing a sheet of flexible material from roller 32 and adhering a flexible mesh from roller 34 to the sheet. According to an exemplary embodiment, the flexible mesh can form ribs extending from at least one surface of the sheet. The adhering process can be formed utilizing adhering apparatus 40. For example, adhering apparatus 40 can be a heat supply that melts pliable polymeric material from roller 32 engaging mesh material from roller 34. Alternatively, mesh material 34 can be pliable and adhere to flexible material 32 utilizing adhering apparatus 40. According to an example embodiment, at least one of the two rolls of material to be adhered together can be oriented above the other rolls of material. For example, roll 34 can be oriented above roll 32 in relation to forming bed 38. According to another embodiment, the adhering process can encase mesh from roll 34 within the flexible material from roll 32.

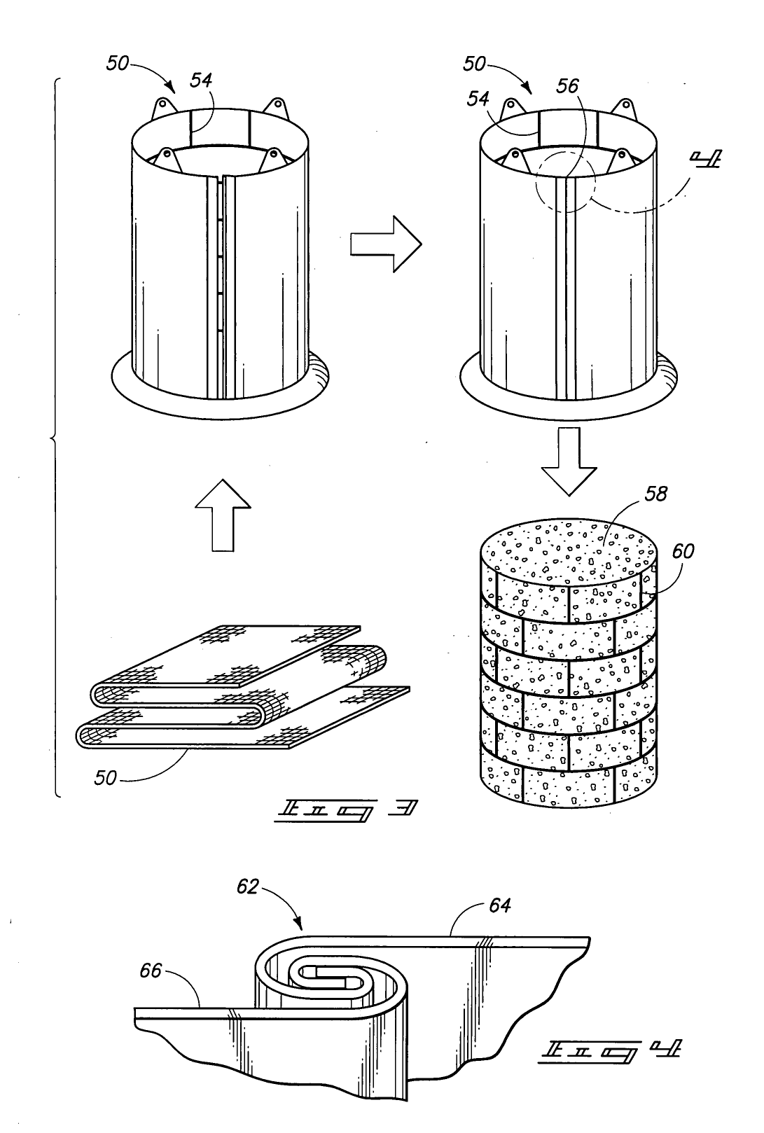

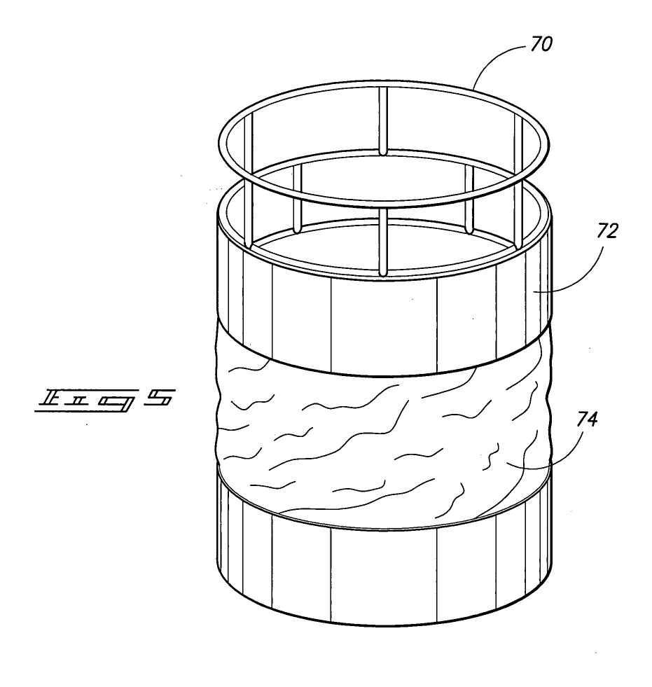

Referring to FIGS. 3 and 4, another embodiment of the present disclosure is provided. Form insert 50 can be configured to be provided in folded sheets, for example, to conserve storage space at the construction site. As such, these sheets can be stacked on top of one another and stored away in relatively small spaces until needed for use. Sheets 50 can then be unfolded and then aligned in a cylindrical fashion and as aligned, they can form an insert to be provided within a form to house material to be cured. As an example embodiment, forms 50 can include ribs 54 defining a perimeter of the columnar form. The ribs can be coupled to one another by interconnecting members to form a frame. For example, opposing ends of form 50 can be coupled to one another to form a cylindrical construction. As such, upon material curing, columns can be provided that can include architectural features such as indentations outlining a brick construction. Indentations 60 can be consistent with ribs 54, for example.

Referring to FIG. 4, another example embodiment for the coupling of opposing ends of material 50 is shown. As can be seen, portion 66 of material 50 can form a complimentary hook portion to a hook portion of portion 64 of material 50. These hooks can be aligned together and compliment one another, engaging one another at portion 62, for example.

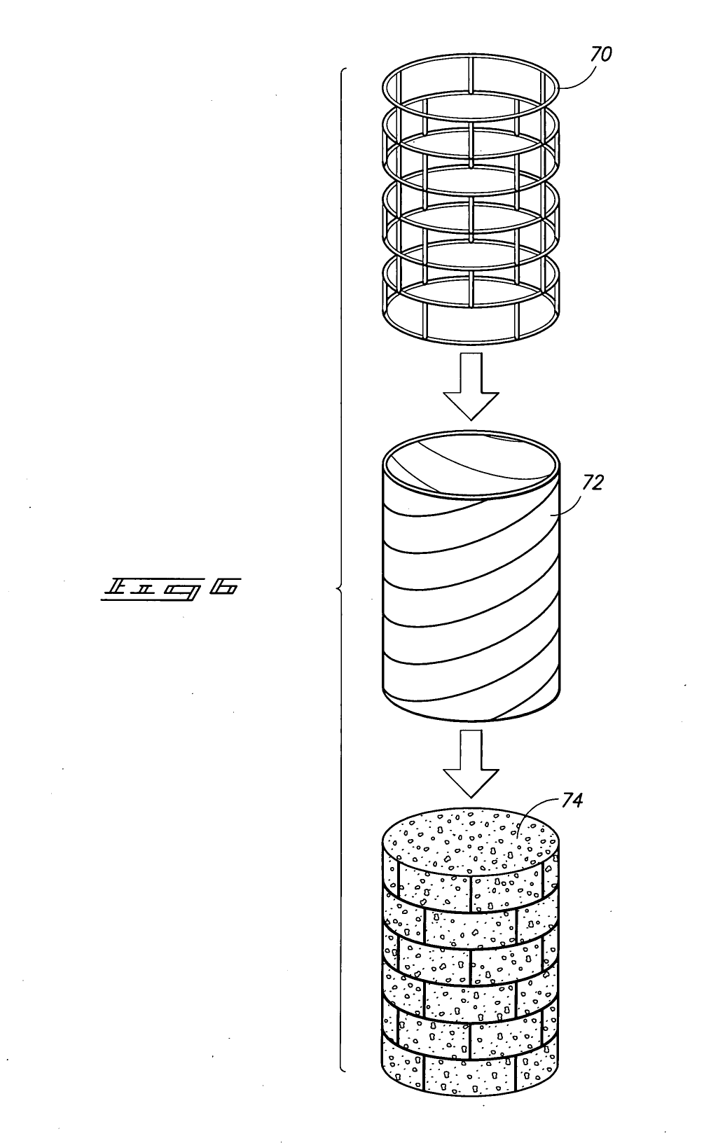

Referring to FIG. 5, and still another embodiment, construction 70 can include a frame or mesh of ribs that can be aligned within a form 72 having cured material therein. According to an exemplary embodiment and referring to FIG. 6, construction 70 can be placed within a form 72 and then upon curing of material 74, the construction 70 can be removed, as well as form 72, to provide a column 74 of the cured material having exposed architectural features.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. A form insert comprising a flexible sheet having multiple ribs extending from at least one surface of the sheet.

2. The form insert of claim 1 wherein the ribs are configured to form a mesh.

3. The form insert of claim 1 wherein the ribs are configured to form a decorative pattern.

4. The form insert of claim 1 wherein the ribs are configured to form an architectural feature.

5. A method of curing material within a form comprising:
expanding a sheet over an interior portion of one form defining a perimeter of material to be cured, wherein the sheet comprises ribs extending from a surface of the sheet to within the perimeter;
providing the material to be cured within the form, the material receiving at least a portion of the ribs of the sheet;
curing the material; and
removing the sheet from the material.

6. The method of claim 5 wherein ribs are configured to provide openings within an exterior surface of the material upon removal of the sheet.

7. The method of claim 5 wherein the form is cylindrical.

8. The method of claim 5 wherein the expanding comprises coupling one end of the sheet with an opposing other end of the sheet to form a cylinder.

9. The method of claim 8 wherein the ribs extend within the cylinder.

10. The method of claim 5 further comprising, before providing the material to be cured, supplementing a portion of the sheet between the ribs with an additional architectural form.

11. The method of claim 10 wherein the additional architectural form comprises a substrate having a plurality of peaks and valleys.

12. A column form insert comprising a plurality of circular ribs defining a perimeter of a column form, the ribs being coupled to one another by interconnecting members to form a frame.

13. The form insert of claim 12 wherein the frame is configured as an outline of an architectural feature.

14. The form insert of claim 13 wherein the frame is configured to outline stone masonry.

15. The form insert of claim 12 wherein one end of the insert is configured to couple with another opposite opposing end of the insert to form a cylinder.

16. The form insert of claim 12 wherein the insert is configured to slidably engage a cylindrical concrete form.

17. A method of producing a form insert comprising providing a sheet of flexible material and adhering a flexible mesh to the sheet, the flexible mesh forming ribs extending from at least one surface of the sheet.

18. The method of claim 17 wherein both the sheet of flexible material and the flexible mesh are provided in rolls.

19. The method of claim 18 wherein one of the rolls is oriented above the other roll and the material and mesh are extended over an adhering table and then wound to form a roll of insert.

20. The method of claim 18 further comprising another roll of flexible material, the roll of mesh being oriented between the rolls of flexible material.

21. The method of claim 20 wherein the flexible material from each of the rolls is adhered to one another, the adhering encasing the mesh within the flexible materials.
